(19) United States
(12) Patent Application Publication
(10) Pub. No.: US 2008/0268829 A1
(43) Pub. Date: Oct. 30, 2008

(54) METHOD AND APPARATUS FOR USER PERSONALIZED MOBILE VIDEO PROGRAM LIST POPULATION

(75) Inventors: Carolyn Taylor, Chicago Heights, IL (US); Yi Qiao, Hoffman Estates, IL (US); Theodore S. Rzeszewski, Wheaton, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/739,249

(22) Filed: Apr. 24, 2007

(51) Int. Cl. H04M 3/00

(52) U.S. Cl. 455/420

(57) ABSTRACT

Methods and apparatuses that simplify user access to various desired programming over a mobile device are disclosed. In (601) the user selects a program and in (603) an ESG data fragment is checked for a criteria. In (605) the appropriate field of the various ESG fields may be checked to determine whether the selected program matches an existing criteria. If not, then the users selections are continued to be monitored. If a criteria matches, then in (607) a check of whether a previous selection matching the particular criteria was made previously. If the criteria was previously selected, then the index is incremented, and a threshold is checked in (613). If the threshold is exceeded (613), a group will be created (615) corresponding to user selections (601). If the number of selections has not exceed the threshold in (613), no new group will be created.

### FIELD OF THE DISCLOSURE

The present disclosure is related generally to mobile video broadcast systems, such as Digital Video Broadcasting (DVB), and to personalized content delivery to a mobile device, and more specifically to Electronic Service Guides (ESG) or Electronic Program Guides (EPG) provided to mobile devices by such broadcast systems.

### BACKGROUND

The advent of various high data rate/throughput wireless technologies such as exemplified by the Digital Video Broadcast (DVB) and DVB-Handheld (DVB-H) standards, has led to the capability to provide video services, such as television broadcasts, over mobile handheld devices.

The development of mobile television has also included the development of an Electronic Service Guide (ESG) which may also be referred to as an Electronic Program Guide (EPG). An ESG in concept is broadcast by a media broadcasting system usually to an application residing on an electronic device, such as, but not limited to a mobile device such as a cellular telephone.

The device user may access the ESG and navigate through it, for example, by scrolling through a listing, and thereby obtain information about current and future programming such as television or radio programs. For DVB, the European Telecommunications Standards Institute (ETSI) has developed standards for the ESG. For example, ETSI TS 102 471, DVB IP Datacast Over DVB-H: Electronic Service Guide (ESG) (April 2006) defines the datamodel, representation format, and the encapsulation and transport of a DVB-H ESG.

A user may, by navigating through an ESG using a mobile device user interface, obtain a variety of information about offered programming as previously mentioned. Additionally, mobile devices may provide a Digital Video Record (DVR) capability similar to a VCR function in which the user may save various programs to memory for subsequent viewing at a convenient time.

Another aspect of such content delivery in general is personalization. Mobile device users in particular readily benefit from personalization in that personalization may limit the time a user spends for data entry and re-entry using the generally small user interfaces which may at certain times also be inconvenient. For example, personalization may involve simplifying user interfaces and reducing menu options to only those items that are most invoked by the particular user. Other sources of inconveniences for the user may be caused by the delivery of data itself. For example, a mobile device having multiple service capabilities could receive multiple ESGs from the services thus creating two sources or listings of similar data increasing the time a user must spend searching through content listings. As one may imagine, this would increase the time setting up a DVR mode to save programming from the various sources.

Thus a need exists for methods and apparatuses that simplify the user's access to various desired programming over a mobile device and limits the time that the user must spend searching for such desired programming.

### BRIEF DESCRIPTION OF THE DRAWINGS

FIG. 1 illustrates a mobile device with a graphical user interface and displaying an Electronic Service Guide for a mobile application.

FIG. 2 illustrates further details of an Electronic Service Guide (ESG) in accordance with the embodiments.

FIG. 3 illustrates a mobile device in accordance with the embodiments.

FIG. 4 illustrates a method of operation for user selection of content in accordance with the embodiments.

FIG. 5 illustrates a method of operation for populating content groups in accordance with the embodiments.

FIG. 6 illustrates a method of operation for defining content groups in accordance with the embodiments.

FIG. 7 illustrates an exemplary user quick list in accordance with the embodiments.

### DETAILED DESCRIPTION

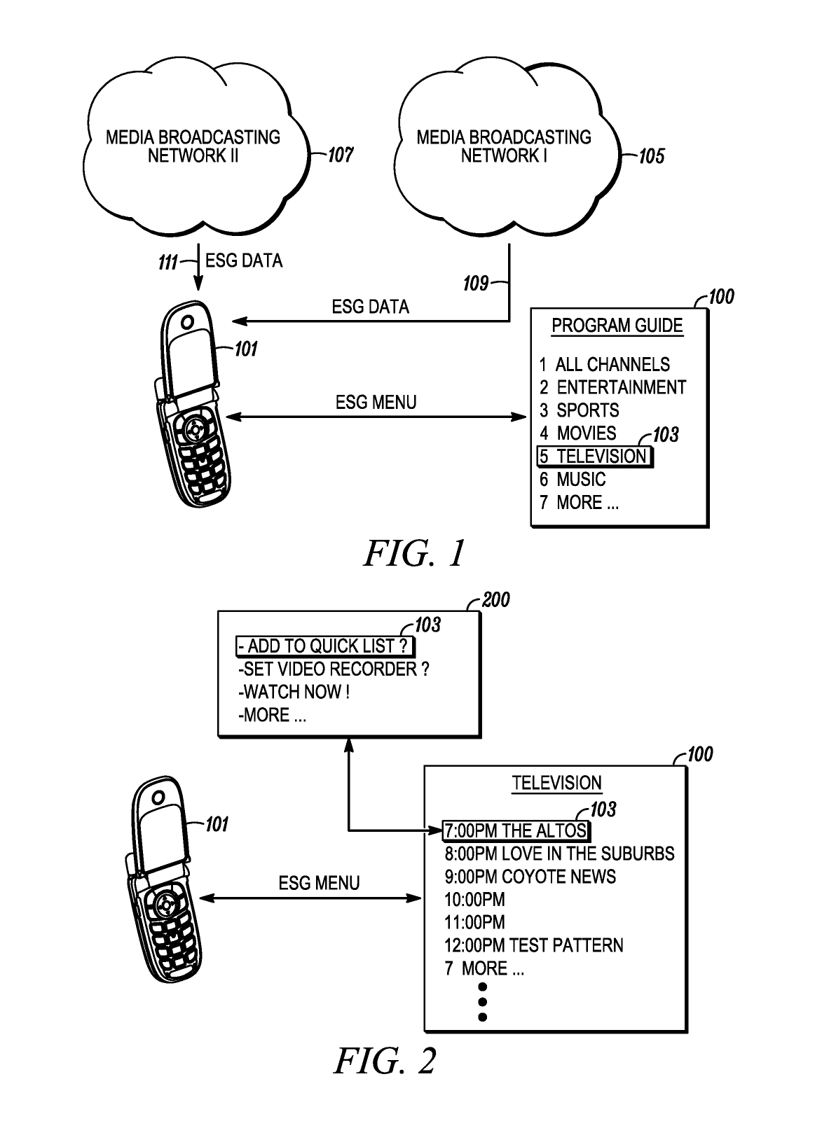

Turning now to the drawings, FIG. 1 illustrates a mobile station 101 which has the capability of receiving broadcasts from one or more networks. For example, mobile station 101 may be capable of receiving media broadcasts from media broadcasting network I 105 and media broadcasting network II 107. The media broadcasting networks may broadcast using any suitable technology however for the embodiments, at least one network will be a Digital Video Broadcasting (DVB) network.

Therefore in FIG. 1, media broadcasting network I 105 may be a DVB-H network and media broadcasting network II 107 may be a Multimedia Broadcast/Multicast Service (MBMS) network. Both networks will provide Electronic Service Guide (ESG) data to the mobile station 101. For example, the DVB-H network will provide an ESG as generally defined by ETSI TS 102 471, DVB IP Datacast Over DVB-H: Electronic Service Guide (ESG) (April 2006) which is incorporated by reference herein.

The specification of ETSI TS 102 471 defines the datamodel, representation format, and the encapsulation and transport of a DVB-H ESG such that ESG data 109 may be sent to mobile station 101. Similarly, ESG data 111 from the media broadcasting network II 107 may be sent using some standard appropriate for the network such as MBMS for example.

In any embodiment, mobile station 101 will receive ESG data from at least one network. The ESG data 109 is used by an application residing within mobile station 101 to display a program guide on a main menu 100 of the mobile station 101 display.

FIG. 1 provides an example of what the program guide of the menu 100 may appear like, however it is to be understood that FIG. 1 is exemplary only and that the program guide may take any suitable format suitable for display on the mobile station 101 graphical display.

The menu 100 will provide a way to navigate the menu such as cursor 103 which, in this example, may be scrolled over the list and used to select an item from the list by, for example, hitting an entry key of the mobile device 101 or by using any other suitable form of user action to make the selection, when the cursor 103 is positioned over, or such that it highlights, the desired selection item.

FIG. 2 provides a further example of navigation of the ESG. The example of FIG. 2 assumes that the user in FIG. 1 selected item “5 Television” so that the main menu now displays as shown in FIG. 2, that is, showing a television listing. The television listing may have any suitable information such as, but not limited to, the time of day and the name of the show.

Thus in FIG. 2, the main menu 100 has a set of selectable items which are in this example television shows. A second sub-menu 200 may be obtained by selecting one of the television shows. For example, sub-menu 200 provides a list of options whereby the user may select to record a show, watch a show, or add a show to a quick list.

It is to be understood that FIG. 1 and FIG. 2 are exemplary and for illustrative purposes only of how a selectable menu system may be provided in conjunction with an ESG. Many other configurations and “look-and-feel” approaches are possible for presenting ESG information and allowing user selectability and any such suitable approaches are within the scope of the various embodiments disclosed herein.

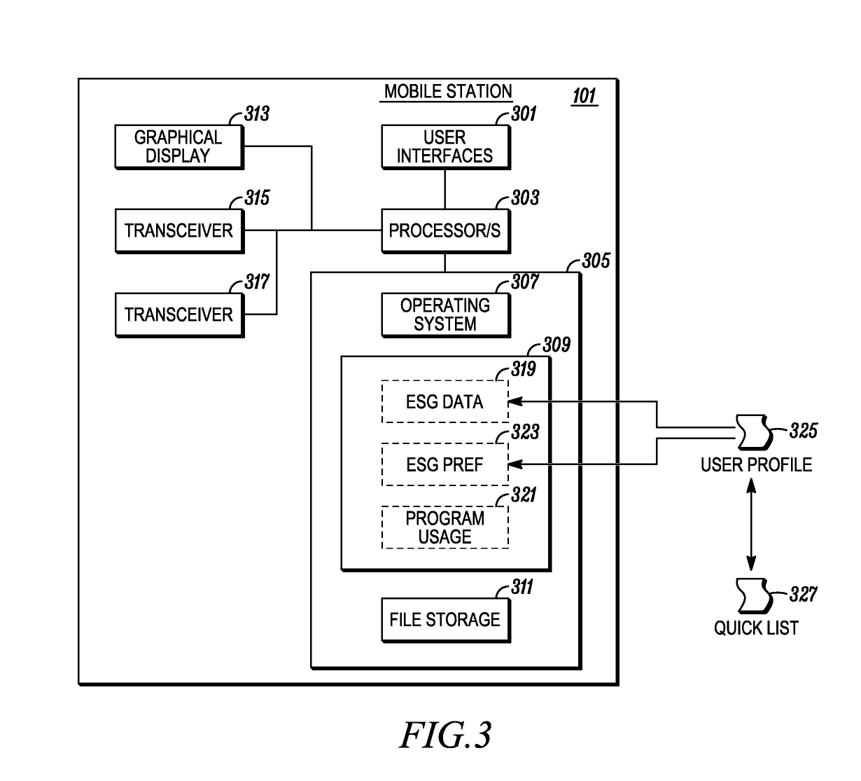

FIG. 3 is a block diagram illustrating components of a mobile station in accordance with the various embodiments. Mobile station 101 comprises at least user interfaces 301, at least one processor 303, a memory 305, a graphical display 313 and one or more transceivers 315, 317 which may be capable of receiving signals from multiple antennas and from various networks such as, but not limited to, a DVB network and/or an MBMS network.

The mobile station 101 memory 305 may further comprise an operating system 307 and have file storage 311. In the various embodiments, the memory 305 may be one or more separate components and/or may be partitioned in various ways for various purposes such as but not limited to, optimizing memory allocations, etc. Thus it is to be understood that the exemplary memory modules illustrated in FIG. 3 are for illustrative purposes only, for the purpose of explaining and assisting one of ordinary skill in understanding the various embodiments described herein.

Therefore, in the various embodiments, mobile station 101 may have ESG data module 319 for storing ESG data received by at least one network such as ESG data 109 illustrated in FIG. 1. As mentioned with respect to FIG. 2, a user may select from a menu, to add a program to a quick list. In some embodiments, a program quick list 327 may be stored in memory as a part of ESG preferences in an ESG preferences module 323. The quick list 327 of the various embodiments will be a subset of the user profile 325 and will be described in further detail below. Other user settings such as, but not limited to, times at which to automatically record various programs, such as for a Digital Video Recored (DVR) mode, may be stored in ESG preferences 323.

The various embodiments may also comprise program usage module 321 which will be described in further detail below, along with the ESG preferences module 323. Generally, in the embodiments, a user profile 325 will be present and will contain the programming information of the various ESGs received from the various networks. The user profile 325 may be contained in the ESG Preferences module 323 and/or the ESG data module 319. However, the received ESG data will be contained by the user profile 325 regardless of any memory modules. As discussed, more than one ESG may be stored, and may be consolidated into the quick list 327 as will be described in further detail below.

It is to be understood that FIG. 3 is for illustrative purposes only and is primarily for, although not soley for, explaining the information stored in memory for the various embodiments of a mobile station in accordance with the present disclosure, and is not intended to be a complete schematic diagram of the various components and connections therebetween required for a mobile station. Therefore, a mobile station will comprise various other components not shown in FIG. 3, and/or have various other configurations internal and external, and still be within the scope of the present disclosure.

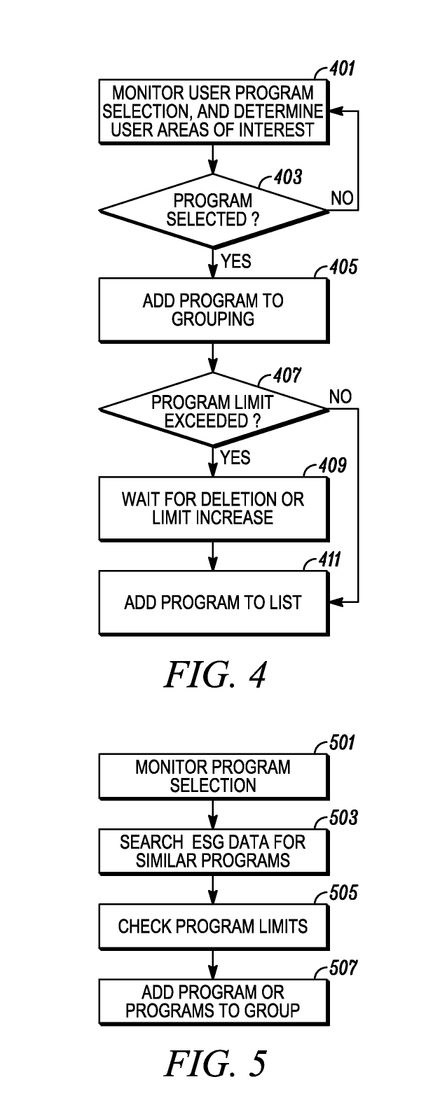

FIG. 4 is a flow chart illustrating operation of mobile station 101 in accordance with the embodiments and as illustrated in the block diagram of FIG. 3. In 401, the program usage module 321 monitors the user's program selection and determines the user's areas of interest. For example, if the user often selects sports programming, then the program usage module 321 will collect a record of the number of times sports programming was selected. In some embodiments a threshold may be set such that an indicator will be recorded if the number of times a certain genre of programming is selected by the user exceeds the threshold. This will be explained in further detail below.

Returning to FIG. 4, in 403 a user may select a program, by for example making a selection from an ESG as shown in FIG. 1 and FIG. 2. If a grouping exists for the particular program, as will be explained in further detail below, the program is added to the grouping as shown in 405. Each grouping may have a predetermined program limit in some embodiments. Other embodiments may have an overall program limit such that the total number of programs added to groups will be limited to a predetermined number. In any case, if the program limit is not already exceeded in 407, the program will be added to the user's quick list 411.

The user's quick list simplifies the amount of data that the user must scroll or otherwise search or surf through on the mobile station 101 graphical display in order to locate and select desired content. If the program limit is exceeded in 407, then the program usage module 321 may wait for a deletion or limit increase as in 409 before adding the program to the list as in 411. Alternatively, the process may cease such that new programs can only be added if space is available in the overall list or group list.

FIG. 5 illustrates further details of how a program may be added to a program group. In 501 the user may select a program from the ESG. In 503, the program usage module 321 will search the ESG for similar programs. The search may be conducted based on various criteria. For example, the ESG data contains various data fragments that may be used in the various embodiments to categorize or otherwise group content. For example, the ESG may contain a service fragment that further contains data fields such as, but not limited to, a “ServiceNumber,” ServiceGenre,” “RelatedMaterial,” and “PrivateData,” field. The ESG may also contain one or more content fragments having data fields such as, but not limited to, a “Genre,” “RelatedMaterial,” “PrivateData,” and “contentID” field. Any of these fields, as well as any other field, may be used as a criteria for establishing a content group for the mobile station 101 user.

As previously mentioned, limits may be set on the amount of program information that may be stored in a group, or in the user's overall quick list. The limits may be set in various ways in the embodiments. For example, the mobile station user may have an option of setting limits on the number of programs, or such limits may be set during provisioning of the mobile station by the network operator. In other embodiments the limits may be set by the network operators or service provider by transmitting the settings to the mobile station. In yet other embodiments, the limits may be set by various combinations of user settings, network operator settings, and/or service provider settings. Thus in 505 the program limits are checked and, if not exceeded, the similar program (or programs) is added to the group, the similar program being similar to the program selected by the user in 501.

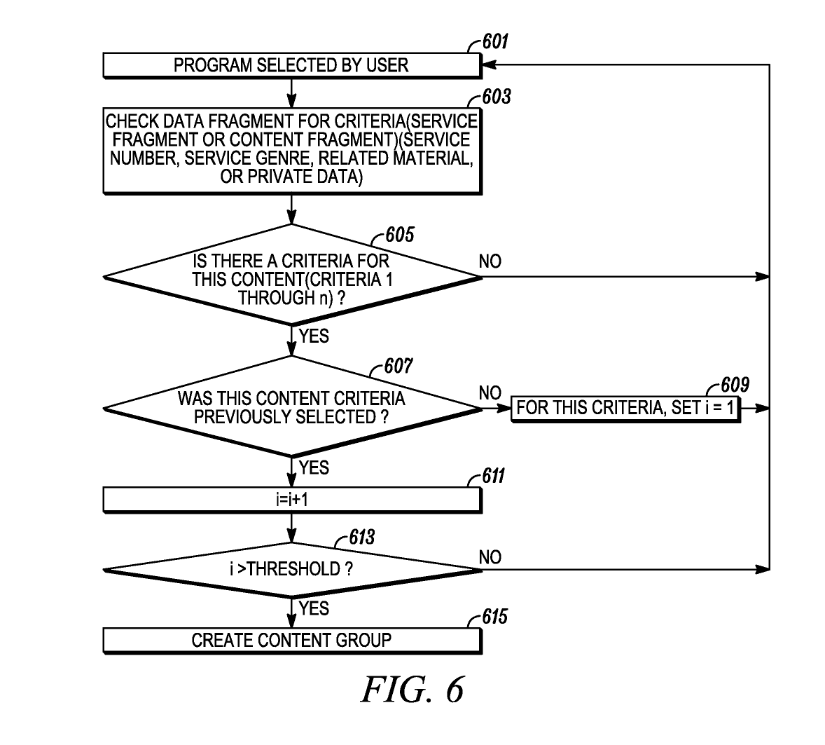

FIG. 6 illustrates an approach for establishing groups based on the interests of the mobile station 101 user. Thus in 601 the user selects a program and in 603 a data fragment of the ESG is checked for a criteria associated with the program. Note that this action may be performed at various levels of granularity. That is, the program may be selected from a service provider, such as one of the media broadcasting networks I 105 and II 107 where the media broadcasting networks broadcast only a given genre, such as for example, classic comedy movies. In this case the ESG from that specific network may have an associated “ServiceGenre” field which may be used as a high level criteria. In other embodiments, the “Genre,” “RelatedMaterial,” “PrivateData,” or “contentID” fields from a content fragment may be used as a criteria. Thus, in the various embodiments, many approaches are possible for selecting by a user and/or predetermining by a network service provider, a set of criteria for defining content groups for a specific user. Therefore, the “criteria” may be predetermined by the network service provider and programmed into the mobile station 101 memory as part of the ESG data 319 and/or the ESG preferences 323 so that it is stored in an involatile manner and cannot be changed by the mobile station 101 user. In other embodiments, various menus may be provided by an application of mobile station 101 such that the user may determine what groups are defined for the purpose of populating a user quick list.

Returning to FIG. 6, in 605 the appropriate field of the various ESG fields may be checked to determine whether the selected program matches an existing criteria of at least one criteria but possibly a number of criteria “n.” If not, then the users selections are continued to be monitored as in 601. If a criteria matches, then in 607 a check of whether a previous selection of content matching the particular criteria was made previously. The check of 607 may have a timeout feature in some embodiments such that content selections older than a certain number of days, weeks, or months as appropriate are not considered. In any case, if a previous selection was not made, or in the embodiments having a timeout, was not made within the time period, an index is set to one, corresponding to the particular criteria. The user's selections are then monitored once again in 601.

If content of the given criteria was previously selected in 607, then the criteria index is incremented by one, and a threshold is checked in 613. The threshold may be a predetermined threshold such that, when the user selections of content of a given criteria exceed the threshold it is assumed that the particular content is of special interest to the user. For example, a threshold of 3 selections may be used to indicate a special or high interest. Any reasonable number may therefore be used as a threshold in accordance with the embodiments. Thus, if the threshold is exceeded in 613, a group will be created in 615. The group corresponds to the criteria previously defined, and by the user selections of 601. If the number of selections has not exceed the threshold in 613, no new group will be created and the user's selection will be continued to be monitored in 601.

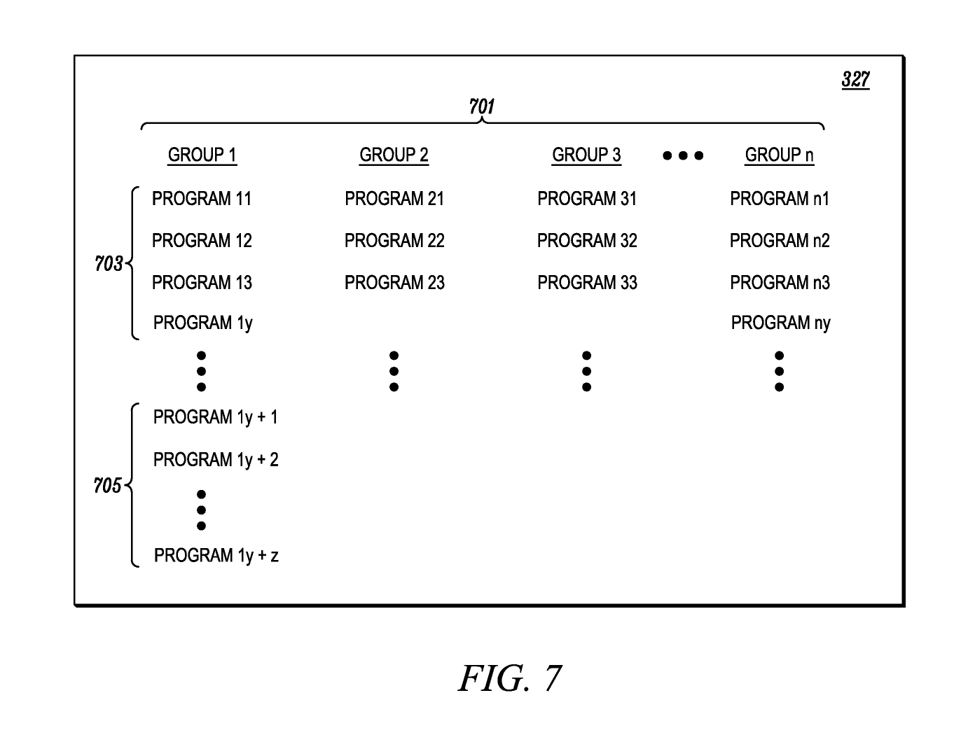

FIG. 7 illustrates the general structure of the user quick list 327 in accordance with the embodiments. The quick list may be stored in the ESG preferences 323 and provides the user with a subset of the user profile 325 as was discussed with respect to FIG. 3. As shown in FIG. 7, the list may comprise a number of groups 1 through n 701, each group corresponding to a content criteria and a user interest. Each group may have program information for a number of programs 1 through y which are selected by the user, such as programs 703. Each group may also have a program information for a number of programs 705 that are added automatically based on the methods described with respect to FIG. 4 and FIG. 5.

Further in the various embodiments, the methods described above are applied to ESG data from one or more networks such as media broadcasting networks 105 and 107. The users quick list 327 will therefore consist of program information from one or more networks in a consolidated manner such that the user may select favorite programs from any network for which the mobile station 101 has access.

Therefore, in accordance with the various embodiments described above, the mobile station 101 user will have a quick list 327 that simplifies the user's task of navigating, or surfing through, an extensive ESG and/or multiple extensive ESGs, and may more easily locate content of interest. It is to be understood that the list 327 may provide access to various types of media content and that some embodiments may provide a list for only one type of content such as television programs, while other embodiments may provide a mix of media content types, such as, but not limited to, television programs, radio programs, music videos, web site URLs, etc. and that criteria may be set such that groups of interest to the user may comprise any combination of such media content types in accordance with the embodiments.

What is claimed is:

1. A method of operating a mobile station comprising:
monitoring a user's program selection, said program selection being made from at least one Electronic Service Guide (ESG);
for said program selection, adding program information corresponding to said program selection to a program list, said program list being a subset of said ESG;
setting a program list limit for a total number of programs added to said program list; and
populating said program list with a set of program information, said set of program information being based on said monitoring of said user's program selection.

2. The method of claim 1, wherein the step of monitoring a user's program selection, said program selection being made from at least one Electronic Service Guide (ESG), further comprises:
establishing at least one criteria related to ESG programs, said at least one criteria defining at least one program group; and
checking said user's program selection for said at least one criteria.

3. The method of claim 2, wherein the step of populating said program list with a set of program information, said set of program information being based on said monitoring of said user's program selection, further comprises:
searching said ESG for programs having said at least one criteria matching said user's program selection;
obtaining at least one program information having said at least one criteria;
adding said at least one program information to said at least one program group; and
adding said at least one program group to said program list.

4. The method of claim 3, further comprising:
setting a group list limit for a total number of programs contained in said at least one program group; and
adding said at least one program information to said at least one program group only if said group list limit is not exceeded by said adding.

5. The method of claim 3, further comprising:
adding said at least one program information to said at least one program group only if said program list limit is not exceeded by said adding.

6. The method of claim 2, wherein the step of establishing at least one criteria related to ESG programs, said at least one criteria defining at least one program group, further comprises:
receiving said at least one criteria from a network.

7. The method of claim 2, wherein the step of establishing at least one criteria related to ESG programs, said at least one criteria defining at least one program group, further comprises:
providing a selectable menu via a graphical interface of said mobile station, said selectable menu providing a set of selectable categories;
receiving at least one selected category, selected by said user from said selectable menu; and
establishing said at least one criteria corresponding to said selected category.

8. The method of claim 7, wherein the step of establishing said at least one criteria corresponding to said selected category further comprises:
using a data field of a data fragment of said ESG as said at least one criteria.

9. The method of claim 8, wherein said data fragment is an ESG service fragment or an ESG content fragment.

10. The method of claim 9, wherein said data field is a service number, service genre, related material, private data, genre, or, content identification field.

11. The method of claim 1, wherein said program selection being made from at least on ESG further comprises said program selection being made from a user profile, said user profile containing program information from said at least one ESG and wherein the step of adding said program to program list, said program list being a subset of said ESG, further comprises:
adding said program to said program list, said program list being a subset of said user profile.

12. A method of operating a mobile station comprising:
monitoring a user's program selection, said program selection being made from at least one Electronic Service Guide (ESG);
checking at least one data field of an ESG information associated with said program;
creating a program group corresponding to said at least one data field;
adding said program selection to said program group;
creating a program list comprising said program group;
adding said program group comprising said program selection to said program list, said program list being a subset of said ESG;
searching said ESG for similar programs, said similar programs having an identical data field to said at least one data field; and
adding said similar programs to said program group of said program list.

13. The method of claim 12, further comprising:
setting a group program limit for a total number of programs contained in said program group; and
adding said similar programs to said program group only until said group program limit is reached.

14. The method of claim 12, further comprising:
setting a program list limit for a total number of programs contained in said program list; and
adding said similar programs to said program group only until said program list limit is reached.

15. The method of claim 12, further comprising:
setting a group program limit for a total number of programs contained in said program group;
setting a program list limit for a total number of programs contained in said program list;
adding said similar programs to said program group only until either said group program limit is reached or until said program list limit is reached.

16. The method of claim 12, wherein the steps of checking at least one data field of an ESG information associated with said program, and creating a program group corresponding to said at least one data field, further comprising:
checking if a criteria has been set, said criteria corresponding to said at least one data field, said criteria having an associated threshold;
maintaining a count of the number of times said criteria has been selected;
determining by said count that the number of times said criteria has been selected exceeds said threshold; and
creating a program group corresponding to said at least one data field in response to said determining by said count that the number of times said criteria has been selected exceeds said threshold.

17. The method of claim 16, wherein said data field is a service number, service genre, related material, private data, genre, or, content identification field.

18. A mobile station comprising:
a transceiver; and
at least one processor coupled to said transceiver, said transceiver and said processor configured to:
receive at least a Digital Video Broadcast (DVB) Electronic Service List (ESG), each program entry of said ESG comprising associated data fields comprising a service number, service genre, related material, private data, genre, or content identification field;
monitor a user's program selection, said program selection being made from said ESG;
add said program to a program list, said program list being a subset of said ESG;
set a program list limit for a total number of programs added to said list; and
populate said list with a set of programs, said set of programs being based on said user's program selection.

19. The mobile station of claim 18, said processor further configured to:
establish at least one criteria related to ESG programs, said at least one criteria defining at least one program group; and
check said user's program selection for said at least one criteria.

20. The mobile station of claim 19, said processor further configured to:
search said ESG for programs having said at least one criteria matching said user's program selection;
obtain at least one program having said at least one criteria;
add said at least one program to said at least one program group; and
add said at least one program group to said list.

21. The mobile station of claim 20, said processor further configured to:
set a group list limit for a total number of programs contained in said at least one program group; and
add said at least one program to said at least one program group only if said group list limit is not exceeded.

22. The mobile station of claim 20, said processor further configured to:
add said at least one program to said at least one program group only if said list limit is not exceeded.

23. The mobile station of claim 19, said processor further configured to establish at least one criteria related to ESG programs, said at least one criteria defining at least one program group, by:
receiving said at least one criteria from a network.

24. The mobile station of claim 19, said processor further configured to establish at least one criteria related to ESG programs, said at least one criteria defining at least one program group, by:
providing a selectable menu via a graphical interface of said mobile station, said selectable menu providing a set of selectable categories;
receiving at least one selected category, selected by said user from said selectable menu; and
establishing said at least one criteria corresponding to said selected category.

25. The mobile station of claim 24, said processor further configured to establish said at least one criteria corresponding to said selected category by:
using a data field of a data fragment of said ESG as said at least one criteria.
